(19) United States
(12) Patent Application Publication
(10) Pub. No.: US 2012/0032792 A1
(43) Pub. Date: Feb. 9, 2012

(54) DISPLAY APPARATUS FOR A VEHICLE

(75) Inventor: Gerd BITZ, Mainz (DE)

(73) Assignee: GM GLOBAL TECHNOLOGY OPERATIONS LLC, Detroit, MI (US)

(21) Appl. No.: 13/198,799

(22) Filed: Aug. 5, 2011

(30) Foreign Application Priority Data
Aug. 5, 2010 (DE) 102010033517.7

(51) Int. Cl. G09F 9/00; B60Q 1/00

(52) U.S. Cl. 340/441; 340/461; 340/449

(57) ABSTRACT

A display apparatus is provided for a vehicle that includes, but is not limited to a scale having a plurality of scale values for at least one associated operating parameter of the vehicle, including, but not limited to an indicator for the display of a current operating parameter value. The scaling of the scale is variable and an adaptation of the scaling is made depending on the current operating parameter.

### CROSS-REFERENCE TO RELATED APPLICATION

This application claims priority to German Patent Application No. 102010033517.7, filed Aug. 5, 2011, which is incorporated herein by reference in its entirety.

### TECHNICAL FIELD

The technical field relates to a display apparatus for a vehicle for the display of information, which is relevant for a vehicle driver (hereinafter called driver) during operation of the vehicle or in other situations. The information can, for example, be information on an operating parameter of the vehicle and the current operating parameter values thereof.

### BACKGROUND

Deduced from the German Unexamined Laid-Open Patent Application DE 101 40 065 A1 is a method for representing combined instrument displays for an automobile and an instrument arrangement, in particular a combination instrument, for an automobile. In this case, the combination instrument is generated virtually on a screen surface without analog instruments. This virtual representation can be supplemented depending on driving and/or operating parameters by virtual variable, e.g., flashing, displays. One embodiment is the virtual analog representation of a tachometer on acquiring or reaching a critical driving situation. In this case, other representations such as, for example, a speedometer display can be temporarily switched off or prevented as required.

Against this background, it is at least one object to provide a display apparatus for vehicle operating parameters, which can be read off by the driver with increased accuracy or simply, and which at the same time enables a situation-adapted representation of additional information as required. In addition, other objects, desirable features and characteristics will become apparent from the subsequent summary and detailed description, and the appended claims, taken in conjunction with the accompanying drawings and this background.

### SUMMARY

Accordingly, a display apparatus is provided for a vehicle comprises a scale having a plurality of scale values for at least one associated operating parameter of the vehicle and an indicator for the display of a current operating parameter value, wherein the scaling thereof is variable and an adaptation of the scaling is made depending on the current operating parameter.

Within the framework of the present invention, scaling is to be understood as the division of the scale, i.e. the spacing of the individual values or value ranges—as it were the resolution of the scale. An advantage is in the situation-adapted flexible display of information on an operating parameter depending on the operating parameter, or it current value, itself, for example, depending on the current operating parameter value or a current value range of the operating parameter. By means of the operating parameter, current driving or traffic situations can additionally be deduced and consequently the display can be flexibly adapted to predefined situations. At the same time, an operating parameter value range, which is particularly important for a current driving situation and the assessment thereof, can be represented in a particularly accurately readable manner with high resolution of the scale.

The dependence of the scaling on the current operating parameter can be implemented differently. For example, an adaptation of the scaling is feasible after the current operating parameter has lain for a predefined time period within a predefined operating parameter value range. In addition, the scaling can be adapted when a detection device detects, for example, a traffic sign, which gives reason to expect a predefined behavior of the operating parameter and/or an associating driving or traffic situation. For example, a traffic sign can be identified, which gives reason to expect that the operating parameter will lie within a predefined operating parameter value range for a time period temporally following the detection of the traffic sign. Within the framework of the embodiments of the present invention, the term indicator is to be understood as an element of the display apparatus, which displays a current operating parameter value through its position, form, shape, etc.

Further details, aspects, and advantages of the invention are the subject matter of the dependent claims, the drawings, and the respective description thereof.

In an embodiment, the indicator is a pointer, which points to a point or range of the scale corresponding to the value of the current operating parameter. A particularly expedient and clear variant for the display of current operating parameter values is thereby given. This variant additionally corresponds to current display devices for the display of operating parameters, in which a pointer points to the current value of the respective operating parameter. The pointer can be a pivotally or rotatably mounted indicator needle, which moves the needle tip along the scale through a pivoting or turning movement so that the tip points to the current operating parameter value.

According to a further embodiment, the indicator identifies the current operating parameter value in color. Due to this embodiment of the invention, additional information is provided to the vehicle driver in a particularly advantageous and convenient manner. A display of an operating parameter value through color identification for example stimulates the attentiveness of a driver and therefore contributes to driving safety. At the same time, for example, the color red can be used within an operating parameter value range, in which a risk for the vehicle occupants or a malfunction of the vehicle is to be expected.

According to another embodiment, the indicator identifies the current operating parameter value by means of variation of the display brightness. By this means, in a monochrome or multicolor display apparatus the range of the scaling which corresponds to the current operating parameter value can be characterized in a particularly expedient manner. If the current operating parameter value, for example, is characterized by an increased display brightness, the driver can rapidly and simply read the current operating parameter value through a cursory glance at the display apparatus.

According to another embodiment, the scaling has a higher resolution at low operating parameter values, that is, the division is enlarged at least in the range of the current operating value, the scale is therefore “stretched” or expanded. This higher resolution of the scale enables a particularly accurate reading of a current operating parameter value. In particular, in one phase of the vehicle operation, in which the current operating parameter values lies within a low operating parameter value range, it is particularly expedient to adapt the scaling to this current operating parameter value range. By this means, the scale for the display of an operating parameter can be optimally utilized and simply and accurately read.

An example for a situation-adapted resolution of the scaling is a traffic situation, in which a maximum value of a predefined operating parameter, e.g., a vehicle maximum speed, must not be exceeded. The resolution of the scale usually oriented to the maximum performance or speed of the vehicle with a significant value range above the permissible maximum is not reached at all in this situation and in this respect remains useless. In this situation, the resolution of the scaling is increased by extending the operating parameter value range lying below the maximum, e.g., to the entire available scale length, i.e. the scale now ends with the maximum value or slightly there above.

According to a further embodiment, the scale has a partial region for the display of further information when the operating parameter lies within a predefined operating parameter value range. By this means, a partial region of the scale area, which lies outside a predefined operating parameter value range and which is not used for “expansion” of the scale can be used in a particularly expedient manner for the display of further information. For example, in the case of a currently low operating parameter value, it is feasible to use the range of high operating parameter values to display further information.

According to a further embodiment, the information represents a further operating parameter. In this way, the function of the area of the scale which lies outside the predefined operating parameter value range can be changed in a particularly simple manner to display a further operating parameter. For example, it is feasible in this case that a further indicator appears on the display apparatus, which displays the current value of the further operating parameter.

In another embodiment, the operating parameter is the vehicle speed. The embodiment can develop its potential particularly well in the display of the vehicle speed since the vehicle speed in certain phases of the driving operation frequently lies within a predefined operating parameter value range (speed range). If, for example, the vehicle moves at a low speed in a zone having a permitted maximum speed, a partial region of the scale above the permitted maximum speed can be used, for example, to display a further operating parameter. In addition, during operation within the zone having a permitted maximum speed, the scaling can be adapted, i.e., spread or expanded, to the speed range to be expected in the current driving operation, i.e., below the permitted maximum speed.

If the vehicle is moving, for example, in a so-called 30 speed zone, i.e., in a public road traffic zone, within which vehicles are only allowed to travel with a speed limit of 30 km/h, the part of the scale range which represents vehicle speed (significantly) above 30 km/h is advantageously available for the display of a further operating parameter. In particular in regions or countries in which speed limits apply generally in the entire traffic area, which are stipulated, for example, by ordinance, the display apparatus according to the invention can expediently by adapted to the general speed limit. The identification as to whether the vehicle is located in a speed limit or in a country having a general speed limit can be accomplished by means of navigation systems and GPS. A color identification of the current vehicle speed is additionally feasible, e.g., with the color red, if this lies above a predefined speed limit and/or a permitted maximum speed.

In a further advantageous embodiment, the operating parameter is the engine speed of the vehicle drive. In particular, in phases of vehicle operation in which the engine speed lies within a predefined engine speed range, the partial region of the scale which lies outside this engine speed range, for example, can be used for the display of further information. An example situation is driving on the freeway with low traffic density, where the vehicle travels at constant speed. In this case, the engine speed lies almost constantly within a situation-determined engine speed range. In this situation the scaling can be adapted to the current engine speeds. To this end, the scale range which represents the situation-determined engine speed range, is, for example, shifted toward one end of the scale and at the same time has a higher resolution, i.e., is represented with a coarser division and therefore with further spaced scale values. In addition, another partial region of the scale at the other end of the scale is used to display another operating parameter. The further operating parameter can, for example, be the currently available fuel supply (tank display). In addition, it is feasible to identify the current engine speed in color, e.g., red, if this exceeds a predefined limiting engine speed, optionally for a predefined time period.

In a further embodiment, the operating parameter is the temperature of a vehicle operating means, e.g., the engine oil. During normal vehicle operation this operating parameter (operating means temperature) usually lies approximately constantly with only small fluctuations within a comparatively small operating temperature range. In this case of application, the display apparatus according to the present invention uses the scale range outside the operating temperature range to display another operating parameter or further information.

### BRIEF DESCRIPTION OF THE DRAWINGS

The present invention will hereinafter be described in conjunction with the following drawing figures, wherein like numerals denote like elements, and:

FIG. 1 shows a display apparatus according to an embodiment of the invention in a vehicle;

FIG. 2 shows an exemplary embodiment of a display apparatus according to an embodiment of the invention; and

FIG. 3 shows an embodiment of a display apparatus according to an embodiment of the invention.

### DETAILED DESCRIPTION

The following detailed description is merely exemplary in nature and is not intended to limit application and uses. Furthermore, there is no intention to be bound by any theory presented in the preceding background or the following detailed description.

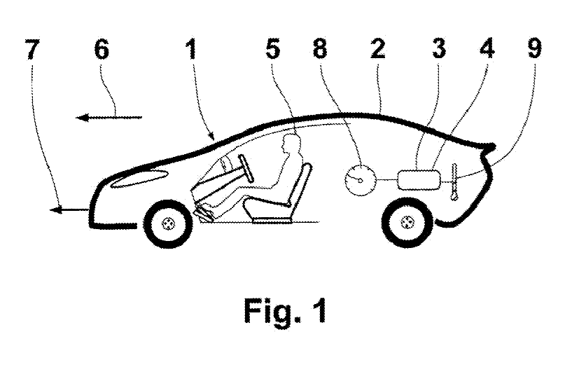

FIG. 1 shows a display apparatus 1 as part of a vehicle 2 having a vehicle drive 3, which comprises an engine 4. A driver 5 is located in the vehicle 2. The vehicle 2 moves in the direction of travel 6 at a vehicle speed 7, wherein the engine 4 turns at an engine speed 8 and wherein the engine oil of the vehicle drive 3 has a current temperature 9.

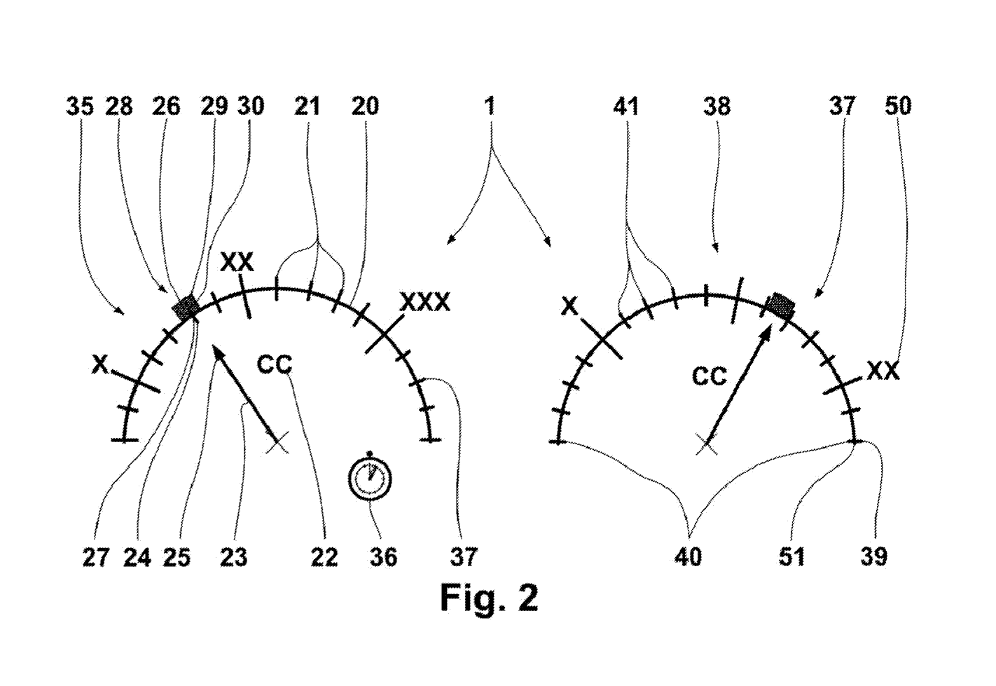

FIG. 2 shows in further detail a possible embodiment of a display apparatus 1 having a scale 20, which comprises a plurality of scale values 21 for at least one associated operating parameter 22 (in FIG. 2 identified as “CC”) of the vehicle 2 shown in FIG. 1. At the same time, an indicator 23 is used to display a current operating parameter value 24. The indicator here is designed as a pointer 25, which is pivotable and gives the current operating parameter value 24 by pointing to a corresponding point 27 or range 28 of the scale 20. In addition, the current operating parameter value 24 is characterized in color 29 and by means of variation of the display brightness 30.

In the situation shown in FIG. 2 on the left, the operating parameter 22 reproduced by the display apparatus 1 adopts comparatively low operating parameter values 35. If this is the case for a comparatively long predefined time period 36, the scaling 37 is adapted to the lower operating parameter values 35 and therefore the value range of the operating parameter 22. This adaptation is accomplished by a higher resolution 38 and adaptation to the current operating parameter value range 40, as shown in FIG. 2 on the right. Here the scale is now adapted by providing an enlarged scaling 41. In other words: the scale has a higher resolution or an enlarged division with a now overall reduced total value range (i.e., the range between minimum and maximum of the scale) since the relative spacings of the adjacent scale values are increased compared with the situation shown in the left part of FIG. 2, the scale values are therefore spaced further apart.

The display apparatus 1 shown in FIG. 2 is used to display the vehicle speed 7 as operating parameter 22. The situation shown comprises driving operation within a traffic-calmed zone having a permitted maximum speed for vehicles, for example, a so-called 30 zone. In this case, the pointer indicates lower operating parameter values 35 (i.e., relatively low vehicle speed values) usually below and slightly above, e.g. up to approximately 40 km/h, the permitted maximum speed 50 (i.e., approximately 30 km/h). Accordingly the current scaling 41 is adapted to the low range of the operating parameter values 35 so that, as shown in FIG. 2 on the right, the permitted maximum speed 50 lies in the range of the right end 51 of the scale 20 with current scaling 41. As a result, the currently displayed, comparatively low operating parameter values 35 are displayed with higher resolution 38, therefore more easily and accurately identifiable for the driver.

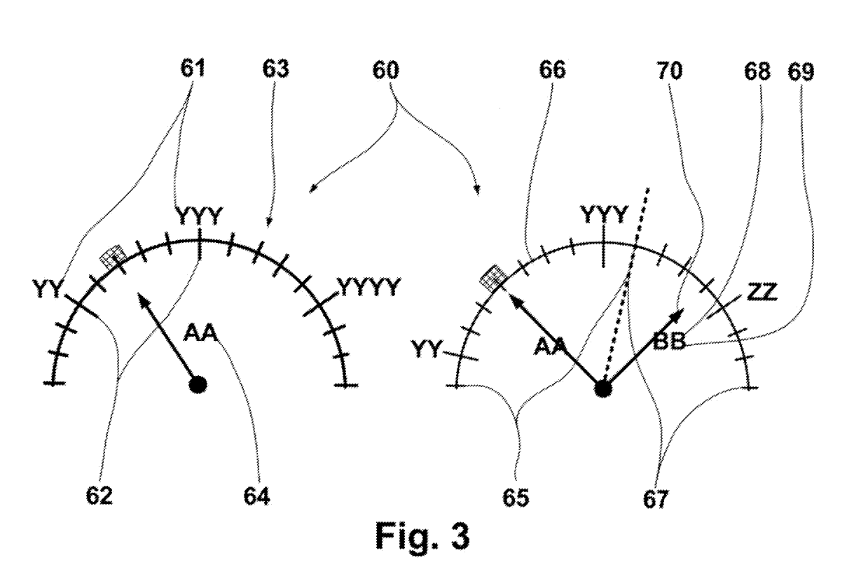

The embodiment of a display apparatus 60 shown in FIG. 3 is constructed substantially as the display apparatus 1 shown in FIG. 2. In this case, the display apparatus 60 is used to display the engine speed 8 of the vehicle drive 3 shown in FIG. 1. In the situation shown the vehicle 2 is located in a driving situation in which the engine speed values 61 lie within a relative small operating parameter value range 62 (i.e., engine speed range). In this situation, the scaling 63 is adapted to the current values of the engine speed 8 as operating parameter 64 (characterized as “AA” in FIG. 3) by on the one hand shifting the engine speed range currently to be expected to the left or in the direction of low operating parameter values into the left partial region 65 of the scale 66 and optionally with higher resolution. A right partial region 67 of the scale 66 not used to display the operating parameter 64 in this situation is advantageously used to display further information 68, as shown in FIG. 3 on the right.

In the embodiment shown in FIG. 3, the further information 68 is a further operating parameter 69 (characterized as “BB” in FIG. 3), for example, the temperature 9 of the engine oil mentioned in connection with FIG. 1. To this end another indicator 70 for display of the further operating parameter 69 appears on the display apparatus 60.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A display apparatus for a vehicle, comprising:
a scale having a plurality of scale values for at least one associated operating parameter of the vehicle; and
an indicator configured to display a current operating parameter value,
wherein the plurality of scale values of the scale is variable and an adaptation of is made depending on a current operating parameter

2. The display apparatus according to claim 1, wherein the indicator is a pointer that points to the scale corresponding to a value of the current operating parameter.

3. The display apparatus according to claim 1, wherein the indicator identifies the current operating parameter value in a color.

4. The display apparatus according to claim 2, wherein the indicator is configured to identify the value of the current operating parameter with a variation of a display brightness.

5. The display apparatus according to claim 1, wherein the scaling has a higher resolution at low operating parameter values.

6. The display apparatus according to claim 1, wherein the scale has a partial region for display of additional information when the operating parameter lies within a predefined operating parameter range.

7. The display apparatus according to claim 6, wherein the information represents a further operating parameter.

8. The display apparatus according to claim 1, wherein the at least one associated operating parameter is a speed of the vehicle.

9. The display apparatus according to claim 8, further comprising a navigation system configured to identify a regional-specific speed restriction, and
wherein the adaptation of the scaling is dependent on the regional-specific speed restriction.

10. The display apparatus according to claim 1, wherein the at least one associated operating parameter is an engine speed of a vehicle drive.

11. The display apparatus according to claim 1, wherein the at least one associated operating parameter is a temperature of a vehicle operating apparatus.
